(19) United States
(12) Patent Application Publication
(10) Pub. No.: US 2023/0176216 A1
(43) Pub. Date: Jun. 8, 2023

(54) AUTOMATIC BOOTSTRAP FOR AUTONOMOUS VEHICLE LOCALIZATION

(71) Applicant: ARGO AI, LLC, Pittsburgh, PA (US)

(72) Inventors: Kunal Anil DESAI, San Francisco, CA (US); Xxx XINJILEFU, Pittsburgh, PA (US)

(73) Assignee: ARGO AI, LLC, Pittsburgh, PA (US)

(21) Appl. No.: 17/542,164

(22) Filed: Dec. 3, 2021

(51) Int. Cl. G01S 17/89; G01C 21/32; G01S 17/08

(52) U.S. Cl. CPC G01S 17/89; G01C 21/32; G01S 17/08

(57) ABSTRACT

An automated bootstrap process implemented as a simple state machine generates an initial pose for an autonomous vehicle, without reliance on human intervention. To trigger initiation of the bootstrap process automatically, the autonomous vehicle remains stationary. A GPS-derived position estimate, combined with lidar sweep data and HD map reference point cloud data, can be used to generate a pose using an iterative closest point algorithm. The bootstrap solution can then be automatically validated by a machine learning-based binary classifier trained with appropriate features. Full automation of the bootstrap process may facilitate launching a fleet service of autonomous vehicles.

### BACKGROUND

When an autonomous vehicle (AV) is initially powered on, its position and orientation with respect to its surroundings, or initial pose, must be determined before the AV can begin to navigate. The process of determining location and orientation of a vehicle within precise parameters may be referred to as localization. Current systems may rely on GPS input to determine an initial pose and verify the pose by relying on a human operator input. Such processes become time consuming and require heavy involvement from human operators, thereby limiting vehicle autonomy, and preventing the deployment of AV fleets.

### SUMMARY

Aspects of the present disclosure provide for systems and methods that enable the full autonomy of AVs, and especially when performing bootstrapping operations. In this regard, reliance on human operator input to validate pose results may be significantly reduced and or eliminated altogether. As such, the disclosed systems and methods enable the deployment of one or more AVs within a fleet operation because the vehicles are less dependent on human operator input. As such, the disclosed systems and methods lead to a reduction of downtimes of the AVs and maximize operational times.

According to some aspects, a computer-implemented method is disclosed that includes generating, by one or more computing devices of an autonomous vehicle (AV), an initial pose estimate of the AV from Global Positioning System (GPS) data, the initial pose estimate including a reference map; generating, by the one or more computing devices, an initial pose of the AV from the initial pose estimate, the generating including: performing a Light Detection and Ranging (lidar) sweep to generate lidar data, generating yaw angle candidates of the AV based on a correlation between the lidar data and the reference map, generating position candidates of the AV based on the reference map, combining the position candidates and the yaw candidates to generate a list of raw candidates, and performing a search operation on the raw candidates to determine the initial pose of the AV; and bootstrapping the AV by transitioning an operating mode of the AV from a running state to a localized state based on the determined initial pose, when the AV is stationary.

According to some aspects, a system is disclosed that includes: a lidar apparatus configured to perform a lidar sweep to generate lidar data; and a computing device of an autonomous vehicle (AV) configured to: generate an initial pose estimate of the AV from Global Positioning System (GPS) data, the initial pose estimate including a reference map; generate an initial pose of the AV from the initial pose estimate; generate yaw angle candidates of the AV based on a correlation between the lidar data and the reference map; generate position candidates of the AV based on the reference map; combine the position candidates and the yaw candidates to generate a list of raw candidates; perform a search operation on the raw candidates to determine the initial pose of the AV; and bootstrap the AV based on the determined initial pose, when the AV is stationary.

According to some aspects, a non-transitory computer-readable medium is disclosed having instructions stored thereon that, when executed by at least one computing device, cause the at least one computing device to perform operations includes: generating an initial pose estimate of the AV from Global Positioning System (GPS) data, the initial pose estimate including a reference map; generating an initial pose of the AV from the initial pose estimate, the generating including: performing a lidar sweep to generate lidar data, generating yaw angle candidates of the AV based on a correlation between the lidar data and the reference map, generating position candidates of the AV based on the reference map, combining the position candidates and the yaw candidates to generate a list of raw candidates, and performing a search operation on the raw candidates to determine the initial pose of the AV; and bootstrapping the AV based on the determined initial pose, when the AV is stationary.

### BRIEF DESCRIPTION OF THE DRAWINGS

The accompanying drawings are incorporated herein and form a part of the specification.

FIG. 1 illustrates an exemplary autonomous vehicle system, in accordance with aspects of the disclosure.

FIG. 2 illustrates an exemplary architecture for a vehicle, in accordance with aspects of the disclosure.

FIG. 3 illustrates an exemplary architecture for a lidar system, in accordance with aspects of the disclosure.

FIG. 4A is a pictorial view of an autonomous vehicle equipped with a lidar apparatus, in accordance with aspects of the disclosure.

FIG. 4B is a top plan view of the autonomous vehicle shown in FIG. 1A, illustrating signals being transmitted and received by the lidar apparatus, in accordance with aspects of the disclosure.

FIG. 5 is a block diagram of a localization system that incorporates data from the lidar apparatus shown in FIGS. 4A-4B, in accordance with aspects of the disclosure.

FIG. 6 is a data flow diagram for the bootstrap solver shown in FIG. 5, in accordance with aspects of the disclosure.

FIG. 7 is a flow diagram of a method of performing a bootstrap process, in accordance with aspects of the disclosure.

FIG. 8 is state diagram associated with an automated bootstrap process, in accordance with aspects of the disclosure.

FIG. 9 is a block diagram of an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for an automated bootstrap process for use in localization of an autonomous vehicle. The automated bootstrap process can generate an initial pose for the autonomous vehicle without reliance on human intervention. Equipping an AV with a self-bootstrap capability can enable the AV to recalibrate its systems on demand, without on-site human intervention. This may advantageously solve a number of challenges that currently require on-site intervention. For example, initiating navigation operations (at a boot time for the AV) or after a critical event occurs that may cause the system to recalibrate (e.g., loss of communication signal, loss of navigation signal, sensor malfunction, and/or a collision event) can be addressed by the AV itself without any on-site intervention.

According to some aspects, the disclosed systems and method reduce the reliance on a human operator to initiate a navigation or address a critical event may not be feasible for deployment within an AV fleet, especially when the AV fleet is geographically dispersed. For example, if every fleet vehicle parked at a random outdoor location in a large city requires human assistance to initiate driving operations, then the fleet is not autonomous and may require significant costs for fleet personnel to be available for troubleshooting activities. As such, aspects of the present disclosure increase the autonomous nature/operations of AVs and further enable the deployment of AV fleets.

According to some aspects, a simple state machine may be combined with a one or more validators to enable automating a bootstrap process. According to some aspects, in order for an AV to trigger a bootstrap operation, the AV needs to be in a stationary position. This enables vehicle sensors to determine vehicle position, pitch, and yaw parameters. According to some aspects, a satellite navigation system's position estimate is produced from, for example, at least four satellites having a horizontal accuracy of at least ten meters. The GPS estimate, combined with lidar sweep data, can be used to specify an initial position and orientation of the vehicle. According to some aspects, a high definition (HD) map may also be used as an input. After the initial pose of the AV is generated, the bootstrap solution can be automatically validated by a machine learning-based binary classifier trained with appropriate features and the AV may be localized.

According to some aspects, full automation of the bootstrap process on an AV can be leveraged to facilitate launching of a fleet service using autonomous vehicles (AVs). While reliance on a human operator to initiate navigation may be workable for a single autonomous vehicle (and perhaps for personal use), such reliance is not feasible for a fleet of AVs, especially when the fleet is geographically dispersed. For example, if every fleet vehicle parked at a random outdoor location in a large city requires human assistance to begin driving, then the fleet is not autonomous. Consequently, full automation is a practical pre-requisite for fleet operation.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

Notably, the present solution is being described herein in the context of an autonomous vehicle. The present solution is not limited to autonomous vehicle applications. The present solution can be used in other applications such as robotic application, radar system application, metric applications, and/or system performance applications.

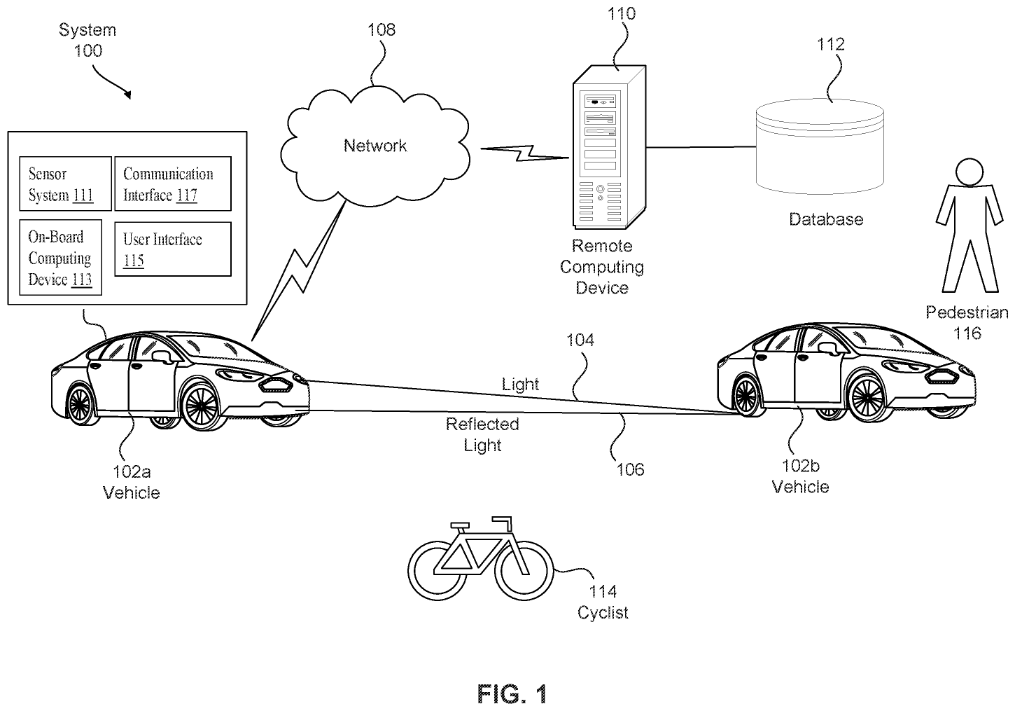

FIG. 1 illustrates an exemplary autonomous vehicle system 100, in accordance with aspects of the disclosure. System 100 comprises a vehicle 102a that is traveling along a road in a semi-autonomous or autonomous manner. Vehicle 102a is also referred to herein as AV 102a. AV 102a can include, but is not limited to, a land vehicle (as shown in FIG. 1), an aircraft, or a watercraft.

AV 102a is generally configured to detect objects 102b, 114, 116 in proximity thereto. The objects can include, but are not limited to, a vehicle 102b, cyclist 114 (such as a rider of a bicycle, electric scooter, motorcycle, or the like) and/or a pedestrian 116.

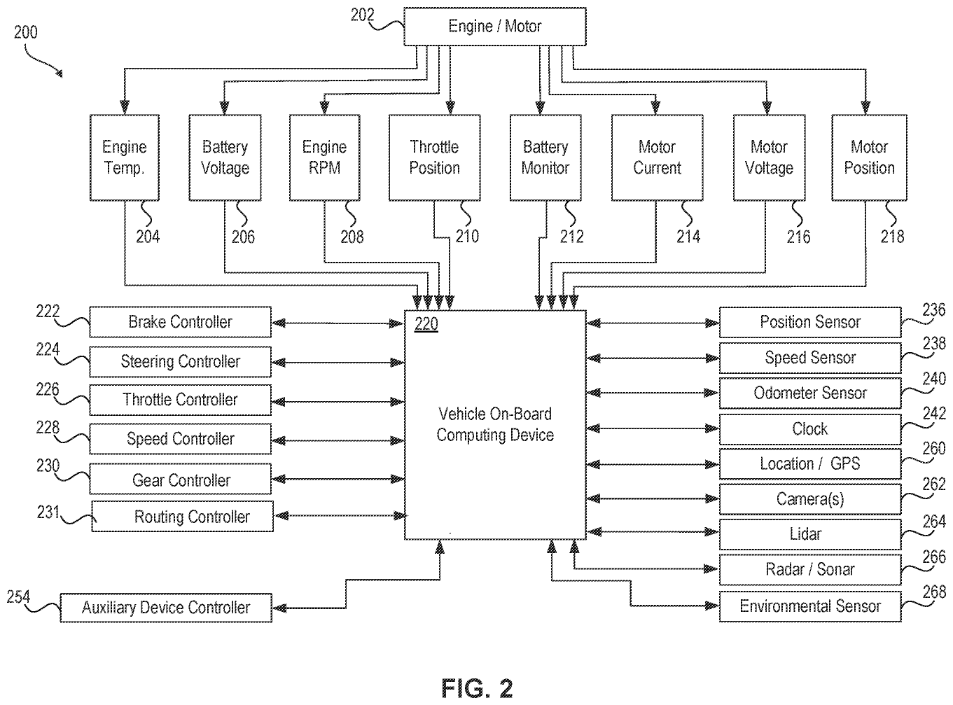

As illustrated in FIG. 1, the AV 102a may include a sensor system 111, a vehicle on-board computing device 113, a communications interface 117, and a user interface 115. Autonomous vehicle 101 may further include certain components (as illustrated, for example, in FIG. 2) included in vehicles, which may be controlled by the vehicle on-board computing device 113 using a variety of communication signals and/or commands, such as, for example, acceleration signals or commands, deceleration signals or commands, steering signals or commands, braking signals or commands, etc.

The sensor system 111 may include one or more sensors that are coupled to and/or are included within the AV 102a, as illustrated in FIG. 2. For example, such sensors may include, without limitation, a lidar system, a radio detection and ranging (RADAR) system, a laser detection and ranging (LADAR) system, a sound navigation and ranging (SONAR) system, one or more cameras (e.g., visible spectrum cameras, infrared cameras, etc.), temperature sensors, position sensors (e.g., global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of the AV 102a, information about the environment itself, information about the motion of the AV 102a, information about a route of the vehicle, or the like. As AV 102a travels over a surface, at least some of the sensors may collect data pertaining to the surface.

As will be described in greater detail, AV 102a may be configured with a lidar system, e.g., lidar system 264 of FIG. 2. The lidar system may be configured to transmit a light pulse 104 to detect objects located within a distance or range of distances of AV 102a. Light pulse 104 may be incident on one or more objects (e.g., AV 102b) and be reflected back to the lidar system. Reflected light pulse 106 incident on the lidar system may be processed to determine a distance of that object to AV 102a. The reflected light pulse may be detected using, in some embodiments, a photodetector or array of photodetectors positioned and configured to receive the light reflected back into the lidar system. Lidar information, such as detected object data, is communicated from the lidar system to an on-board computing device, e.g., vehicle on-board computing device 113 of FIG. 2. The AV 102a may also communicate lidar data to a remote computing device 110 (e.g., cloud processing system) over communications network 108. Remote computing device 110 may be configured with one or more servers to process one or more processes of the technology described herein. Remote computing device 110 may also be configured to communicate data/instructions to/from AV 102a over network 108, to/from server(s) and/or database(s) 112.

It should be noted that the lidar systems for collecting data pertaining to the surface may be included in systems other than the AV 102a such as, without limitation, other vehicles (autonomous or driven), robots, satellites, etc.

Network 108 may include one or more wired or wireless networks. For example, the network 108 may include a cellular network (e.g., a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

AV 102a may retrieve, receive, display, and edit information generated from a local application or delivered via network 108 from database 112. Database 112 may be configured to store and supply raw data, indexed data, structured data, map data, program instructions or other configurations as is known.

The communications interface 117 may be configured to allow communication between AV 102a and external systems, such as, for example, external devices, sensors, other vehicles, servers, data stores, databases etc. The communications interface 117 may utilize any now or hereafter known protocols, protection schemes, encodings, formats, packaging, etc. such as, without limitation, Wi-Fi, an infrared link, Bluetooth, etc. The user interface system 115 may be part of peripheral devices implemented within the AV 102a including, for example, a keyboard, a touch screen display device, a microphone, and a speaker, etc.

FIG. 2 illustrates an exemplary system architecture 200 for a vehicle, in accordance with aspects of the disclosure. Vehicles 102a and/or 102b of FIG. 1 can have the same or similar system architecture as that shown in FIG. 2. Thus, the following discussion of system architecture 200 is sufficient for understanding vehicle(s) 102a, 102b of FIG. 1. However, other types of vehicles are considered within the scope of the technology described herein and may contain more or less elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 2, system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Rotations Per Minute (“RPM”) sensor 208, and a throttle position sensor 210. If the vehicle is an electric or hybrid vehicle, then the vehicle may have an electric motor, and accordingly includes sensors such as a battery monitoring system 212 (to measure current, voltage and/or temperature of the battery), motor current 214 and voltage 216 sensors, and motor position sensors 218 such as resolvers and encoders.

Operational parameter sensors that are common to both types of vehicles include, for example: a position sensor 236 such as an accelerometer, gyroscope and/or inertial measurement unit; a speed sensor 238; and an odometer sensor 240. The vehicle also may have a clock 242 that the system uses to determine vehicle time during operation. The clock 242 may be encoded into the vehicle on-board computing device, it may be a separate device, or multiple clocks may be available.

The vehicle also includes various sensors that operate to gather information about the environment in which the vehicle is traveling. These sensors may include, for example: a location sensor 260 (e.g., a Global Positioning System (“GPS”) device); object detection sensors such as one or more cameras 262; a lidar system 264; and/or a radar and/or a sonar system 266. The sensors also may include environmental sensors 268 such as a precipitation sensor and/or ambient temperature sensor. The object detection sensors may enable the vehicle to detect objects that are within a given distance range of the vehicle 200 in any direction, while the environmental sensors collect data about environmental conditions within the vehicle's area of travel.

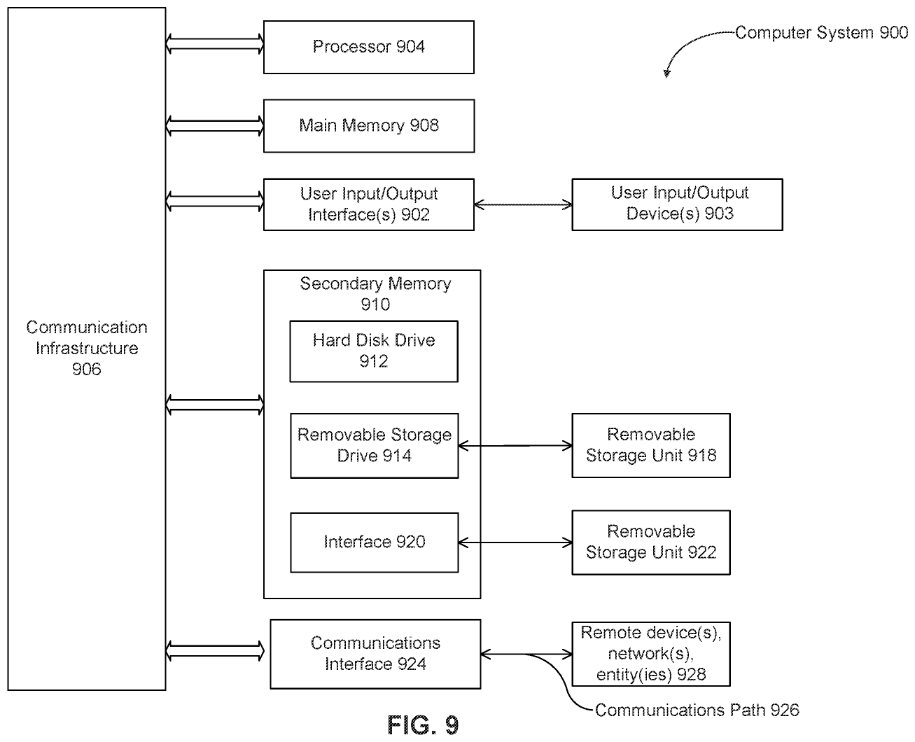

During operations, information is communicated from the sensors to a vehicle on-board computing device 220. The vehicle on-board computing device 220 may be implemented using the computer system of FIG. 9 The vehicle on-board computing device 220 analyzes the data captured by the sensors and optionally controls operations of the vehicle based on results of the analysis. For example, the vehicle on-board computing device 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the vehicle on-board computing device 220, which may then access a map of the environment that corresponds to the location information to determine known fixed features of the environment such as streets, buildings, stop signs and/or stop/go signals. Captured images from the cameras 262 and/or object detection information captured from sensors such as lidar system 264 is communicated from those sensors) to the vehicle on-board computing device 220. The object detection information and/or captured images are processed by the vehicle on-board computing device 220 to detect objects in proximity to the vehicle 200. Any known or to be known technique for making an object detection based on sensor data and/or captured images can be used in the embodiments disclosed in this document.

Lidar information is communicated from lidar system 264 to the vehicle on-board computing device 220. Additionally, captured images are communicated from the camera(s) 262 to the vehicle on-board computing device 220. The lidar information and/or captured images are processed by the vehicle on-board computing device 220 to detect objects in proximity to the vehicle 200. The manner in which the object detections are made by the vehicle on-board computing device 220 includes such capabilities detailed in this disclosure.

The vehicle on-board computing device 220 may include and/or may be in communication with a routing controller 231 that generates a navigation route from a start position to a destination position for an autonomous vehicle. The routing controller 231 may access a map data store to identify possible routes and road segments that a vehicle can travel on to get from the start position to the destination position. The routing controller 231 may score the possible routes and identify a preferred route to reach the destination. For example, the routing controller 231 may generate a navigation route that minimizes Euclidean distance traveled or other cost function during the route, and may further access the traffic information and/or estimates that can affect an amount of time it will take to travel on a particular route. Depending on implementation, the routing controller 231 may generate one or more routes using various routing methods, such as Dijkstra's algorithm, Bellman-Ford algorithm, or other algorithms. The routing controller 231 may also use the traffic information to generate a navigation route that reflects expected conditions of the route (e.g., current day of the week or current time of day, etc.), such that a route generated for travel during rush-hour may differ from a route generated for travel late at night. The routing controller 231 may also generate more than one navigation route to a destination and send more than one of these navigation routes to a user for selection by the user from among various possible routes.

In some embodiments, the vehicle on-board computing device 220 may rely on one or more sensor outputs (e.g., lidar 264, GPS 260, cameras 262, etc.) to generate a high definition (HD) map. The HD map is a highly accurate map containing details not normally present on traditional maps. For example, the HD map may include map elements such as road shapes, road markings, traffic signs, and barriers. Relying on an HD map as an input for a localization process can help reduce error tolerances of other detection sensors and provide for a more accurate localization process.

In various embodiments, the vehicle on-board computing device 220 may determine perception information of the surrounding environment of the AV 102a. Based on the sensor data provided by one or more sensors and location information that is obtained, the vehicle on-board computing device 220 may determine perception information of the surrounding environment of the AV 102a. The perception information may represent what an ordinary driver would perceive in the surrounding environment of a vehicle. The perception data may include information relating to one or more objects in the environment of the AV 102a. For example, the vehicle on-board computing device 220 may process sensor data (e.g., lidar or RADAR data, camera images, etc.) in order to identify objects and/or features in the environment of AV 102a. The objects may include traffic signals, road way boundaries, other vehicles, pedestrians, and/or obstacles, etc. The vehicle on-board computing device 220 may use any now or hereafter known object recognition algorithms, video tracking algorithms, and computer vision algorithms (e.g., track objects frame-to-frame iteratively over a number of time periods) to determine the perception.

In some embodiments, the vehicle on-board computing device 220 may also determine, for one or more identified objects in the environment, the current state of the object. The state information may include, without limitation, for each object: current location; current speed and/or acceleration, current heading; current pose; current shape, size, or footprint; type (e.g., vehicle vs. pedestrian vs. bicycle vs. static object or obstacle); and/or other state information.

The vehicle on-board computing device 220 may perform one or more prediction and/or forecasting operations. For example, the vehicle on-board computing device 220 may predict future locations, trajectories, and/or actions of one or more objects. For example, the vehicle on-board computing device 220 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the AV 102a, the surrounding environment, and/or their relationship(s). For example, if an object is a vehicle and the current driving environment includes an intersection, the vehicle on-board computing device 220 may predict whether the object will likely move straight forward or make a turn. If the perception data indicates that the intersection has no traffic light, the vehicle on-board computing device 220 may also predict whether the vehicle may have to fully stop prior to enter the intersection.

In various embodiments, the vehicle on-board computing device 220 may determine a motion plan for the autonomous vehicle. For example, the vehicle on-board computing device 220 may determine a motion plan for the autonomous vehicle based on the perception data and/or the prediction data. Specifically, given predictions about the future locations of proximate objects and other perception data, the vehicle on-board computing device 220 can determine a motion plan for the AV 102a that best navigates the autonomous vehicle relative to the objects at their future locations.

In some embodiments, the vehicle on-board computing device 220 may receive predictions and make a decision regarding how to handle objects and/or actors in the environment of the AV 102a. For example, for a particular actor (e.g., a vehicle with a given speed, direction, turning angle, etc.), the vehicle on-board computing device 220 decides whether to overtake, yield, stop, and/or pass based on, for example, traffic conditions, map data, state of the autonomous vehicle, etc. Furthermore, the vehicle on-board computing device 220 also plans a path for the AV 102a to travel on a given route, as well as driving parameters (e.g., distance, speed, and/or turning angle). That is, for a given object, the vehicle on-board computing device 220 decides what to do with the object and determines how to do it. For example, for a given object, the vehicle on-board computing device 220 may decide to pass the object and may determine whether to pass on the left side or right side of the object (including motion parameters such as speed). The vehicle on-board computing device 220 may also assess the risk of a collision between a detected object and the AV 102a. If the risk exceeds an acceptable threshold, it may determine whether the collision can be avoided if the autonomous vehicle follows a defined vehicle trajectory and/or implements one or more dynamically generated emergency maneuvers is performed in a pre-defined time period (e.g., N milliseconds). If the collision can be avoided, then the vehicle on-board computing device 220 may execute one or more control instructions to perform a cautious maneuver (e.g., mildly slow down, accelerate, change lane, or swerve). In contrast, if the collision cannot be avoided, then the vehicle on-board computing device 220 may execute one or more control instructions for execution of an emergency maneuver (e.g., brake and/or change direction of travel).

As discussed above, planning and control data regarding the movement of the autonomous vehicle is generated for execution. The vehicle on-board computing device 220 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

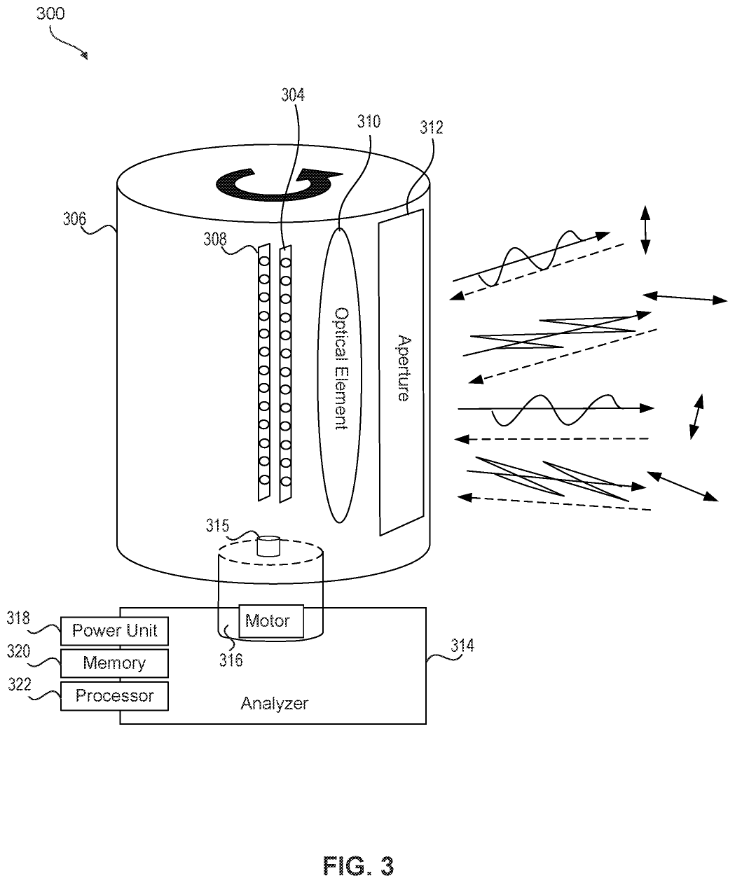

FIG. 3 illustrates an exemplary architecture for a lidar system 300, in accordance with aspects of the disclosure. Lidar system 264 of FIG. 2 may be the same as or substantially similar to the lidar system 300. As such, the discussion of lidar system 300 is sufficient for understanding lidar system 264 of FIG. 2. It should be noted that the lidar system 300 of FIG. 3 is merely an example lidar system and that other lidar systems are further completed in accordance with aspects of the present disclosure, as should be understood by those of ordinary skill in the art.

As shown in FIG. 3, the lidar system 300 includes a housing 306 which may be rotatable 360° about a central axis such as hub or axle 315 of motor 316. The housing may include an emitter/receiver aperture 312 made of a material transparent to light. Although a single aperture is shown in FIG. 3, the present solution is not limited in this regard. In other scenarios, multiple apertures for emitting and/or receiving light may be provided. Either way, the lidar system 300 can emit light through one or more of the aperture(s) 312 and receive reflected light back toward one or more of the aperture(s) 312 as the housing 306 rotates around the internal components. In an alternative scenario, the outer shell of housing 306 may be a stationary dome, at least partially made of a material that is transparent to light, with rotatable components inside of the housing 306.

Inside the rotating shell or stationary dome is a light emitter system 304 that is configured and positioned to generate and emit pulses of light through the aperture 312 or through the transparent dome of the housing 306 via one or more laser emitter chips or other light emitting devices. The light emitter system 304 may include any number of individual emitters (e.g., 8 emitters, 64 emitters, or 128 emitters). The emitters may emit light of substantially the same intensity or of varying intensities. The lidar system also includes a light detector 308 containing a photodetector or array of photodetectors positioned and configured to receive light reflected back into the system. The light emitter system 304 and light detector 308 would rotate with the rotating shell, or they would rotate inside the stationary dome of the housing 306. One or more optical element structures 310 may be positioned in front of the light emitter system 304 and/or the light detector 308 to serve as one or more lenses or waveplates that focus and direct light that is passed through the optical element structure 310.

One or more optical element structures 310 may be positioned in front of a mirror (not shown) to focus and direct light that is passed through the optical element structure 310. As shown below, the system includes an optical element structure 310 positioned in front of the mirror and connected to the rotating elements of the system so that the optical element structure 310 rotates with the mirror. Alternatively or in addition, the optical element structure 310 may include multiple such structures (for example lenses and/or waveplates). Optionally, multiple optical element structures 310 may be arranged in an array on or integral with the shell portion of the housing 306.

Lidar system 300 includes a power unit 318 to power the light emitting unit 304, a motor 316, and electronic components. Lidar system 300 also includes an analyzer 314 with elements such as a processor 322 and non-transitory computer-readable memory 320 containing programming instructions that are configured to enable the system to receive data collected by the light detector unit, analyze it to measure characteristics of the light received, and generate information that a connected system can use to make decisions about operating in an environment from which the data was collected. Optionally, the analyzer 314 may be integral with the lidar system 300 as shown, or some or all of it may be external to the lidar system and communicatively connected to the lidar system via a wired or wireless communication network or link.

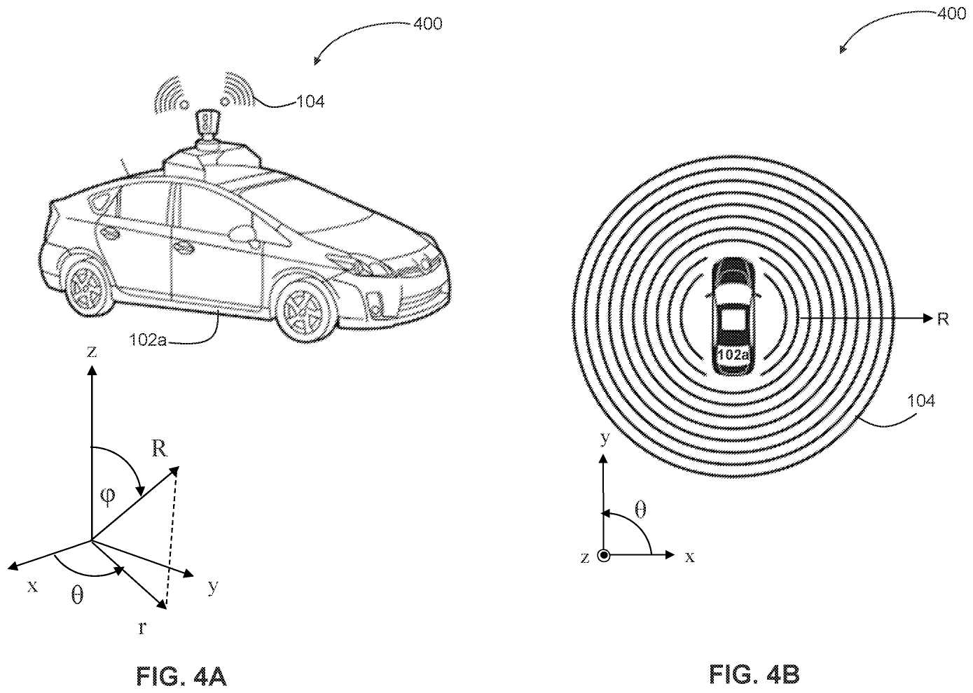

FIGS. 4A and 4B illustrate a lidar apparatus 400, in accordance with aspects of the disclosure. FIG. 4A illustrates a lidar apparatus 400 that may be integrated within autonomous vehicle (AV) 102a according to some embodiments. Lidar apparatus 400 can be attached to the roof of AV 102a, for a clear line of sight from which to emit and detect laser signals 110, e.g., pulsed laser beams. As AV 102a travels through its environment, lidar apparatus 400 can be used, alone, or in conjunction with other sensor devices such as cameras, to determine radial distances (ranges) of various objects in the environment, relative to AV 102a. Objects of interest in the environment of AV 102a may include, for example, buildings, trees, other vehicles, pedestrians, and traffic lights, which are generally located at, or slightly above, ground level.

Referring to FIG. 4B, a laser beam can be swept through selected ranges of azimuthal angle θ and elevation angle φ, so as to propagate laser signals 110 radially outward from the transmitter of lidar apparatus 400, to reflect from objects in the vicinity of AV 102a. For a lidar apparatus 400 that is mounted to the roof of AV 102a as shown in FIG. 4B, the laser beam can be swept through all 360 degrees of azimuthal angle θ while being swept through a smaller range of elevation angle φ (e.g., 45 degrees), to enhance the detection of relevant objects of interest that are located at lower elevations (e.g., on level with AV 102a). Each lidar sweep operation of lidar apparatus 400 may generate lidar sweep data. The lidar sweep data can be stored and processed locally, e.g., in vehicle on-board computing device 220. Alternatively, lidar sweep data can be relayed to a remote computing system for immediate processing and/or storage for future reference. In addition to using lidar data to track traffic, obstacles, and roadways for autonomous driving functions, lidar sweep data can also be used to orient AV 102a on a map for navigation in conjunction with GPS data, as described below.

The use of techniques disclosed herein within the example lidar apparatus 400 may serve to enhance the ability of lidar apparatus 400 to achieve localization of AV 102a. As noted herein, localization may refer to an initial determination of where a vehicle is and its orientation within a predetermined location threshold. It is noted that, although lidar apparatus 400 is depicted in FIG. 4A as being incorporated into AV 102a, and having features as described herein, lidar apparatus 400 may also be implemented in other contexts. Furthermore, techniques described herein that are applied to lidar apparatus 400 may be used outside of the lidar context as well.

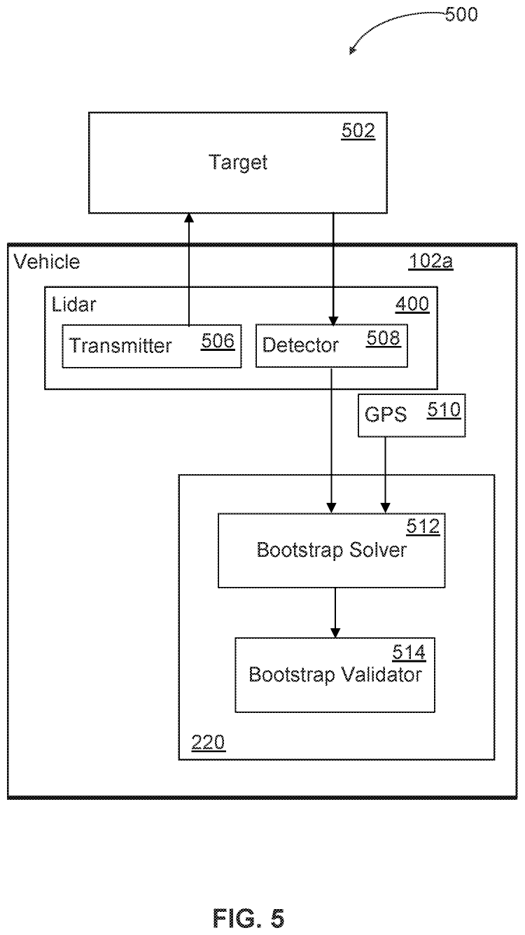

FIG. 5 shows a localization system 500 for operating AV 102a to perform an automatic bootstrap procedure for localization of AV 102a, in accordance with aspects of the disclosure. Localization system 500 includes AV 102a equipped with lidar apparatus 400, as illustrated in FIGS. 4A and 4B, and vehicle on board computing device 220 coupled to lidar apparatus 400, in addition to other sensors described in FIG. 2.

In some embodiments, lidar apparatus 400 generally includes a transmitter 506 and a detector 508. In some embodiments, transmitter 506 is a pulsed laser source configured to transmit laser beam pulses in a radial pattern as shown in FIG. 4B. Transmitter 506 may include a pulse modulator. In some embodiments, detector 508 is configured to detect laser pulse reflections from target 502 using a single photon type of detector, e.g., a detector 508 that indicates whether or not one or more photons has been received.

In some embodiments, vehicle on board computing device 220 can be programmed with a bootstrap solver 512 and a bootstrap validator 514. In some embodiments, bootstrap solver 512 may be a set of instructions implemented according to an algorithm as described herein, for storage on, and execution by, vehicle on-board computing device 220. In some embodiments, bootstrap validator 514 may also be a set of instruction implemented according to an algorithm that can provide an independent check of the results of bootstrap solver 512. Bootstrap validator can also be stored on, and executed by, vehicle on-board computing device 220.

According to some aspects, bootstrap solver 512 receives lidar data input from detector 508 as well as data input from a satellite navigation system, e.g., global positioning system (GPS) 510 and a reference point cloud from the high definition (HD) map. As can be appreciated by those skilled in the art, the HD map may be a map with many different layers of data representing the world, or areas surround the AV. In some aspects, the point cloud contained in the HD map may be just one of the layers of data the HD map contains.

According to some aspects, the point cloud in the HD map is one that has been constructed from many lidar sweeps collected by one or more vehicles across a given area. It is an optimized combination of these lidar sweeps based on proprietary algorithms. According to some aspects of the disclosure, data generated from the on-vehicle lidar sweep is used as a separate input from the HD reference point cloud. For example, the on-vehicle lidar sweep may be a lidar sweep of points that represent the world around the AV in the real time moment (relative to the respective lidar sweep), whereas the HD map reference point cloud is a representation based on lidar sweeps collected over a period of time (likely prior to the current relative time). According to some aspects, bootstrap solver 512 may compare the on-vehicle, real time lidar sweep with the HD map's reference point cloud representation.

In some embodiments, GPS 510 produces a position estimate from a plurality of satellites having a horizontal accuracy of at least ten meters. For example, according to some aspects, four GPS satellites may be used to calculate a precise location of the AV. In this example, signals from three GPS satellites may be used to determine an x-y-z position of the vehicle, and a fourth GPS satellite may be used to adjust for the error in the GPS receiver's clock. It can be appreciated that the number of satellites relied upon impacts the accuracy regarding the GPS position of the AV, as should be understood by those of ordinary skill in the art.

An on-vehicle runtime may be the time required to execute a single cycle for bootstrap solver 512 on vehicle on-board computing device 220. According to some aspects, the on-vehicle run time of bootstrap solver 512 to perform one cycle may be equivalent to less than one minute or even less than thirty seconds. It can be appreciated that the algorithm of bootstrap solver 512 may be designed in a manner to reduce the runtime as needed.

Bootstrap solver 512 can combine information from detector 508 and GPS 510 to determine a position and an orientation, or initial pose, of AV 102a in the context of its environment. The position of AV 102a may refer to a location of AV 102a on a map that can be used as a starting point for automated navigation. The orientation of AV 102a may refer to how AV 102a is situated in its immediate environment, relative to adjacent buildings, traffic signals, and roadway features such as curbs, lane lines, and the like. The initial pose includes six degrees of freedom: x, y, and z coordinates specifying AV 102a's position, and pitch, yaw, and roll values that specify AV 102a's orientation—that is, the direction in which AV 102a is pointing, such that when AV 102a is energized, the initial pose will indicate in which direction AV 102a will begin moving.

In some embodiments, AV 102a may be stored in a depot or a parking garage. In this regard, AV 102a may determine its final pose upon completing a parking operation and communicate the determined final pose to a remote device (e.g., remote computing device 110) or store the final pose locally. According to some aspects, because AV 102a is parked in a known space (e.g., depot/garage), the determined final pose may be used as an initial pose when AV 102a powers back on. This may help accelerate the bootstrap operation step since coordinates associated with the vehicle's location within a depot may be known, thereby foregoing the need for initial GPS data. According to some embodiments, upon powering on, AV 102a may retrieve the stored final pose information, either from local storage or from a remote computing device 110, and proceed to perform the bootstrap operation prior to navigating out of the depot.

Continuing with the depot parking scenario described herein, according to some aspects, when the final pose of AV 102a is known or can be retrieved, one way of managing a subsequent start-up is to skip running bootstrap solver 512 and proceed to run the bootstrap validator 514 on the stored final pose position. If validation fails, then bootstrap solver 512 can be run as usual, followed by bootstrap validator 514. This may be a viable solution to expedite a bootstrapping operation under circumstances where AV 102's last position is known. In a scenario where AV 102a may have been moved to a different location after turning off (e.g., being towed), the bootstrap validator 514 will return a failed result (because the newly detected parameters do not correspond to the last stored final pose). In this case, AV 102a would run a normal sequence of bootstrap solver 512 followed by bootstrap validator 514.

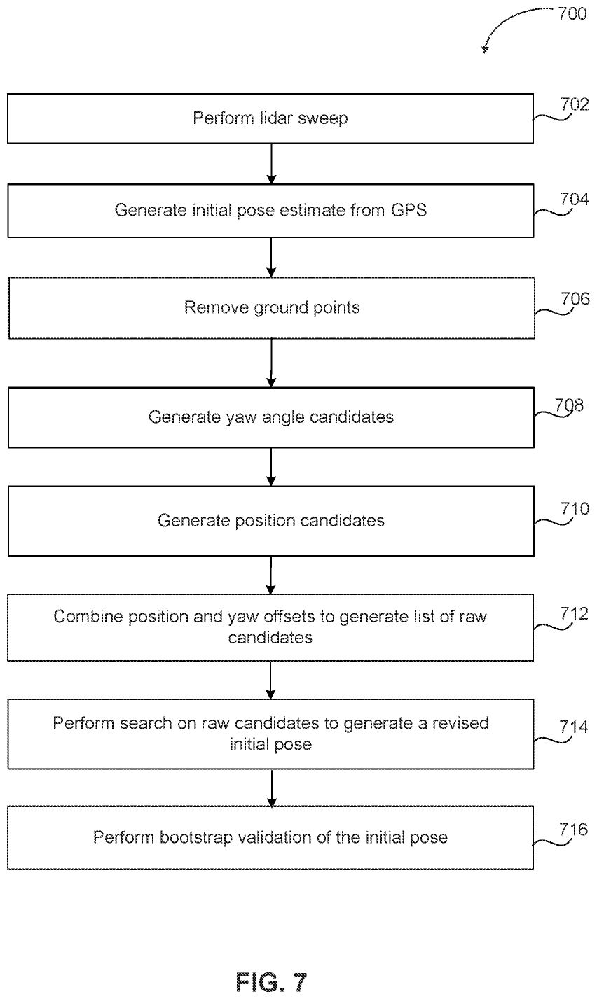

The initial pose, as the output of bootstrap solver 512, can be transmitted to bootstrap validator 514 for testing, to validate the bootstrap solution. Bootstrap validator 514 can be implemented in various forms as will be described below with regard to FIG. 7.

Vehicle on-board computing device 220 may be programmed to implement a method 700 via bootstrap solver 512 and bootstrap validator 514 as described below. Bootstrap solver 512 and bootstrap validator 514 can be implemented in hardware (e.g., using application specific integrated circuits (ASICs)) or in software, or combinations thereof.

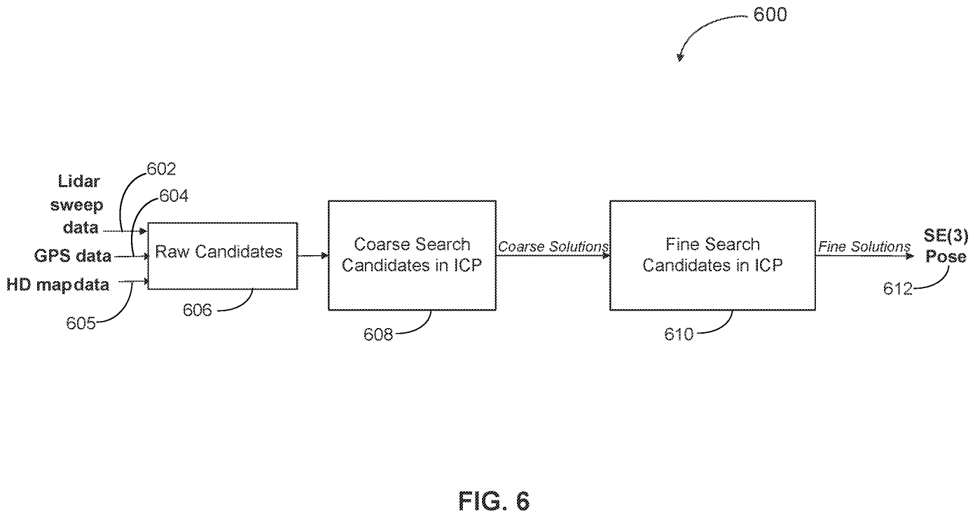

FIG. 6 illustrates data flow 600 schematic associated with bootstrap solver 512 and operations of method 700 as described below with regard to FIG. 7. According to some aspects, data flow 600 may include the following data parameters: lidar sweep data 602, GPS data 604, HD map data 605, raw candidates 606, coarse search candidates 608, fine search candidates 610, and an initial pose 612. As will be further described herein with reference to FIG. 7, lidar sweep data 602, GPS data 604, and HD map data 605 may be used as initial inputs in order to generate raw candidates 606. According to some aspects, when raw candidates 606 are generated, searching operation(s) to generate coarse search candidates 608 and fine search candidates 610 may be performed to provide a more accurate estimation of the AV pose.

FIG. 7 illustrates a method 700 of performing a fully automated, or partially automated, bootstrap process in accordance with aspects of the disclosure. In some embodiments, a fully automated bootstrap procedure is designed to determine an initial position and orientation of AV 102a without human intervention. It can be appreciated that where a fully automated bootstrap procedure may not be possible (e.g., loss of GPS or other communication signal, etc.), a partially automated bootstrap procedure may be performed to determine an initial pose of AV 102a. According to some aspects, a partially automated bootstrap procedure may display concise and clear feedback to a vehicle operator (local within the vehicle or remote), so that the vehicle operator may quickly understand the state of the system and any actions that need to be taken. According to some aspects, the feedback may include a bootstrap status and further instructions/recommendations to the operator for completing the bootstrap operation (e.g., indicating low signal and recommending an operator to move the AV to another location). In some aspects, vehicle on-board computing device 220 may provide the vehicle operator instructions of how/where to move AV 102a to a new location. Vehicle on-board computing device 220 may alternatively determine that it does not have sufficient data to predict a new location based on current GPS, HD map, and lidar input data. In this regard, Vehicle on-board computing device 220 may provide feedback to the operator to find a new location.

At operation 702, a lidar sweep may be performed in accordance with aspects of the disclosure. For example, a light pulse (e.g., light pulse 104) may be transmitted by lidar transmitter 506 to propagate radially outward to encounter a target (e.g. target 502) as illustrated in FIGS. 1, 4, and 5. Target 502 can be, for example, a building, another vehicle e.g., AV 102b, pedestrian 116, cyclist 114, a traffic light, or a curb, as indicated in FIG. 1. Then, reflected light pulse 106 is received from target 502 by detector 508, and a signal corresponding to reflected light pulse 106 is processed as shown in FIG. 5. The transmit/receive sequence is then repeated as lidar transmitter 506 rotates through a prescribed sweep angle to accumulate lidar sweep data (e.g., lidar sweep data 702 discussed herein with reference to FIG. 7).

At operation 704, an initial pose estimate is generated from GPS 510 in accordance with aspects of the disclosure. GPS data 604, obtained from GPS 510, and lidar sweep data 702 may be obtained within one second of one another. In some embodiments, operation 702 may use a grid search assisted by GPS that runs about 20,000 iterations of an iterative closest point algorithm (ICP) to find a final three dimensional pose solution (SE3). In some embodiments, operation 702 simplifies the global search SE3 pose problem to a two-dimensional SE2 problem to solve for xy-translation and yaw. An SE2 pose solution may be obtained with correlation-based processing of lidar sweep data 702 and a reference point cloud. A ground height and ground plane normal vector available from the HD map may be used to create a full SE3 initial pose 712. According to some aspects, the ground height (z value of pose) and the ground plane normal (which gives roll and pitch) may already be pre-calculated across the HD map. Therefore, the problem may be simplified to the remaining variables of x,y, and yaw since the other variables are known from the HD map.

At operation 706, ground points, that is, lidar grid points reflected from surfaces on the ground, can be removed from lidar sweep data 702, in accordance with aspects of the disclosure. Ground points may include signals reflected from curbs, roadway features, lane lines, and the like, which may not be as relevant as landmarks when calculating a pose. In some embodiments, a local line fitting method may be used, such as the method presented in “Fast Segmentation of 3D Point Clouds for Ground Vehicles,” by Michael Himmelsbach, Felix V. Hundelshausen, and H-J. Wuensche. Following removal of ground points, per-point normals may be computed. Per-point normals of the lidar query point cloud may be computed as inputs to the yaw histogram generation and projected into the x-y plane. The xy-normals are then binned at two-degree intervals from −180 to 180 degrees. This generates a count of the number of points with xy plane projected normals in each bin. The histogram can then be normalized.

At operation 708, yaw angle candidates are generated, in accordance with aspects of the disclosure. A yaw angle describes the orientation of AV 102a, that is, in which direction AV 102a is pointing with respect to localized objects, or with respect to roadway features. To generate yaw angle candidates, a yaw histogram can be generated for both the lidar query cloud and the HD map reference cloud. A cross-correlation can then be run between the two histograms. A maximum value of the correlation will correspond to the correct yaw angle solution of the (x,y, yaw) problem being solved. This procedure can quickly calculate the top N (e.g., 4) yaw angles that are most likely to be correct yaw angles of the final solution. This is a faster approach than a brute force method that entails trying every yaw angle (e.g., trying −180 to 180 in one-degree increments for every x,y position under consideration)

According to some aspects, the correlation may be a cross-correlation between yaw histograms of the lidar sweep normal and a reference map normal to generate yaw angle candidates. For example, such correlation may rely on a bin size of 2.0 degrees in a sweep angle of −180 to 180 degrees. The cross-correlation result can be filtered using a Savitsky-Golay filter with a smoothing window size of 9. A two-tier peak check can then be performed on the filtered data, similar to a Canny edge detector, to determine the top four yaw candidates. The two-tier peak check is an algorithm that extracts peaks in a signal or histogram. The peaks may correspond to most likely yaw angles for the x, y, and yaw coordinates.

At operation 710, position candidates are generated, in accordance with aspects of the disclosure. First, a grid of x-y locations can be created within a search radius, (e.g., 12.5 meters), and with a specified grid resolution, (e.g., 1.0 m). At each x-y location, a z-offset can be applied based on ground heights contained in the reference map (e.g., the HD map), to generate three-dimensional position candidates using a sample area size of, for example, 2.0 m. The sample size is approximately the radius from the xy-location of ground heights to be included when calculating the z offset.

At operation 712, position candidates generated at operation 710 can be combined with yaw angle candidates generated at operation 708, and roll and pitch values, to generate a full list of raw candidates, in accordance with aspects of the disclosure. Roll and pitch values can be determined from HD reference map ground normals in the vicinity of the candidate position.

At operation 714, a two-step search of the full list of raw candidates 706 can be performed using an ICP algorithm, in accordance with aspects of the disclosure. In the first step, a coarse search is used to narrow down raw candidates 706 to select a subset for further evaluation using a fine search within a more restricted zone in the second step. First, the coarse search can be performed by applying the ICP algorithm to the raw candidates 706, where ICP algorithm is configured for a coarse search, and then calculating a score for each candidate, normalized to the interval [0, 1], according to the equation score=inlier ratio/avg. residual*0.1. (1)

In equation (1), the inlier ratio is defined as the ratio of inliers, or query points within the query point cloud (e.g., from the lidar), with a match in the reference point cloud from the HD map, divided by the total number of query points. The average residual is defined as the sum of inlier point residual errors divided by the total number of inliers. Coarse search candidates 708 having the N top scores can then be retained as coarse solutions, e.g., for N=5, by keeping the top 5 scores. Solutions to the coarse search then become fine search candidates 610.

At operation 714, following the coarse search, a fine search can be performed on fine search candidates 610 in accordance with aspects of the disclosure. For each of the N coarse search solutions that are retained at operation 714, fine search candidates 610 can be identified within a smaller, fine search radius e.g., 2.1 m and within a fine search yaw angle, e.g., 5.1 degrees. The ICP algorithm can then be configured to perform a fine search and may be applied to each of the fine search candidates 610 as described above, to determine a fine search score normalized to the interval [0, 1]. Again, the top N solutions can be retained, for example, the top 5 solutions, and the top solution can be returned from bootstrap solver 512 as initial pose 612.

At operation 716, a bootstrap validation procedure to provide an independent check of the initial pose 612, in accordance with aspects of the disclosure. In some aspects, the bootstrap validation procedure can be performed automatically by bootstrap validator 514. In some aspects, by using bootstrap validator 514, the bootstrap solution can be automatically accepted or rejected without intervention by a human operator. In some aspects, bootstrap validator 514 may utilize machine learning or artificial intelligence (AI) techniques. In the bootstrap validation procedure, a reference map point cloud (from the HD map) can be used to generate features for AI training, based on range and segmentation labels. A range image encoded with range and label values using a z-buffer method can be rendered from points within a 100 m radius in the reference map from the map-aligned pose solution generated by bootstrap solver 512. Lidar beams for the lidar sensors to be used can be projected into the range image to determine a predicted range and a predicted class label. A lidar sweep can then be used to obtain the observed range. The projection angle can be determined by performing a lidar intrinsic calibration. The location of the lidar relative to the map aligned pose can be determined by performing a lidar extrinsic calibration. According to some aspects, the lidar sweep is the real time lidar sweep used as input for bootstrap solver 512. According to some aspects, the range image may be produced from the points in the HD map's reference point cloud. Thereafter, the potential bootstrap pose solution from bootstrap solver 512 may be used in combination with the AV's knowledge of the laser beam relative to the pose to project into the range image. This projection provides a range value per lidar beam that can then be compared against the actual range that the lidar is reporting for that beam. This projection may be carried out by machine learning example described herein below.

According to some aspects, additional features for use in machine learning during the bootstrap validation procedure can be gathered from ICP information associated with bootstrap solver 512. In some embodiments, a total of, for example, 79 features for use in AI training may include 76 range-based features utilizing 19 class labels (e.g., ground, building, road, and the like), and three ICP-based features (e.g., inlier ratio, matched ratio, and average residual). The 76 range-based features divide a percentage of lidar points into three range categories for each class label: a first range category includes points inside a unit sphere; a second range category includes points on a unit sphere; and a third range category includes points outside a unit sphere, as well as a total percentage of lidar points for each class label. In some embodiments, feature generation is subject to rotation error or translation error, in which the bootstrap solution produced by bootstrap solver 512 is offset from the actual orientation, or the actual position, respectively.

Bootstrap validator 514 can be implemented using one or more machine learning utilities, such as a Linear Support Vector Machine (SVM) validator, a RandomForest validator, a Visual validator, and an SVM Gaussian Kernal validator. In some embodiments, multiple validators can be used to check the validity of pose 613. As an example, the Visual validator uses cameras to gather additional independent information, in the form of visual images of the AV's local environment, to validate the initial pose 612. In some embodiments, different validators may be combined that can complement each other in the overall validation process.

Various validators can be assessed according to factors such as accuracy, precision, recall, and false positive (FP) rate. Such factors are metrics used to characterize performance of machine learning models, and these factors are terms of art, having specific meanings in the field of machine learning. In this context, precision and accuracy are measures of correctness of the machine's performance in classifying data while recall is a measure of completeness of the results of machine-based data classification. A false positive rate may be a critical factor to minimize. For example, if the system incorrectly validates a solution, and this solution is then used by the AV 102a, it could cause the AV to incorrectly perceive its location.

According to some aspects, a Linear SVM Validator may be used to validate a pose produced by the methods described above, to determine validity. According to some aspects, the Linear SVM Validator can achieve a high precision rate (e.g., >99%) with a 93% recall. According to some aspects, an offline testing utilizing a RandomForest validator can also achieve a high precision rate approximately 98.3% accuracy, 99.2% precision, and 97.5% recall, with the added benefit of a false positive rate that is effectively zero. According to some embodiments, a Visual Validator may be used that utilizes camera images from ring cameras mounted to AV 102a and information from an on-vehicle prior map to validate the bootstrap solution. A ScanMatcher Validator can utilize ray tracing with a bounding volume hierarchy to validate the bootstrap solution.

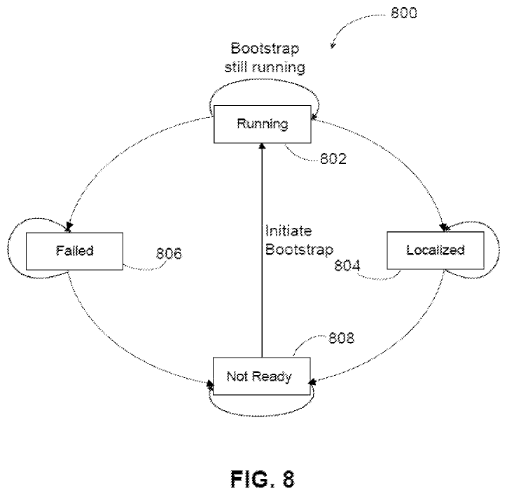

FIG. 8 illustrates a bootstrap state transition flow 800 between exemplary defined states 802-808, during execution of an automated bootstrap process by bootstrap solver 512, when implemented as a state machine. The automated bootstrap process is executed by bootstrap solver 512 according to method 700. A current state, 802, 804, 806, or 808, of the automated bootstrap process may be encoded as a diagnostic signal that can be published periodically as a bootstrap state message (BSM) within localization system 500, at a fixed rate of, for example, 10 Hz. Publication of the BSM can occur, for example, in response to a periodic check of the state of the automated bootstrap process, or in response to a state change, to minimize latency. In some embodiments, information about the current state can be displayed to a vehicle operator via a visualization widget.

In some embodiments, the automated bootstrap process can operate in one of four states: a running state 802, a localized state 804, a failed state 806, or a not-ready state 808. A BSM indicating the current state may be displayed for the vehicle operator or transmitted to a remote location for further analysis. For example, a BSM may displayed as “Bootstrap running” in running state 802; “AV ready to engage autonomous mode” in localized state 804; “Bootstrap failed. Please move to a new location on the map” in failed state 806; and “AV must be stationary to bootstrap” in not-ready state 808.

In some embodiments, a criterion for triggering the automated bootstrap process is that AV 102a be stationary. AV 102a is considered to be stationary when its linear speed, as detected by a motion sensor of the vehicle, is below a configurable, predetermined threshold, throughout a time interval from initiation of the automated bootstrap process to acceptance of the solution by localization system 500. This criterion can be overridden when, e.g., a request diagnostic signal is received that can force a bootstrap attempt. If AV 102a moves during execution of the automated bootstrap process, an early exit request may be submitted to interrupt the automated bootstrap process. Alternatively, execution may continue to completion, at which point the bootstrap solution can be automatically rejected. Motion of AV 102a can be tracked and communicated via a pose interface routine that runs concurrently with the automated bootstrap process, to ensure that AV 102a remains stationary throughout the automated bootstrap process.

In running state 802, localization has been initiated and automated bootstrap process 800 is running, that is, executing method 700, to provide a solution to generate initial pose 712 that characterizes the stationary position and orientation of AV 102a.

In localized state 804, a bootstrap solution where an initial pose 712 has successfully been determined, automatically validated, and accepted, is determined to have taken place. In this state, AV 102a is ready to engage autonomous mode and begin driving. If initial pose 712 is lost after localization has succeeded, the state of automated bootstrap process 800 can revert to not-ready state 808. Otherwise, automated bootstrap process 800 remains in localized state 804. Initial pose 712 can be lost if the stationary position and orientation of AV 102a changes (e.g., if the vehicle moves while the automated bootstrap process is still engaged, prior to entering autonomous mode, or the validation process returns an error).

In failed state 806, the automatic bootstrap process has run, but failed to succeed. In failed state 806, AV 102a is not ready to engage autonomous mode. According to some aspects, to achieve localization following a failed attempt, a vehicle operator may be instructed to move AV 102a to a different location from which another attempt to determine a vehicle position and orientation can be made. When AV 102a has moved to a new location and is again stationary, the state of the automated bootstrap process transitions back to running state 802. It is noted that a bootstrap attempt will always fail to return a solution if the vehicle has moved away from the identified localization location.

It can be appreciated that in failed state 806, AV 102a may determine a preferred bootstrap location based on received GPS data, and AV 102a may output directions to an operator if a vehicle operator is present. Alternatively, AV 102a may determine a new bootstrap location and begin to reposition itself. According to some aspects, a new bootstrap location may be determined to be within a limited radius of the failed bootstrap location (e.g., 10 meters). According to some aspects, AV 102a may determine the new bootstrap location and request that a remote operator navigate AV 102a to the new bootstrap location.

In not-ready state 808, the automated bootstrap process cannot proceed because AV 102a is not ready to be localized. Not-ready state 808 applies when requirements for localization are not met and when a request diagnostic signal is “false.”. Localization requires that AV 102a be stationary. Therefore, if AV 102a is moving, the automated bootstrap process is in not-ready state 808, and cannot initiate the bootstrap process until AV 102a is stationary. When AV 102a becomes stationary, the automated bootstrap process is initiated, and transitions to running state 802.

The criteria for initiating the bootstrap process can be overridden by a request diagnostic signal. When the request diagnostic signal is “true” a bootstrap attempt will be forced to occur. Therefore, the request diagnostic signal is checked when entering, or remaining in, not-ready state 808 to ensure the signal is “false.”

In some aspects, the rate of bootstrapping for initializing the localization system may be once per AV system power-on. In some aspects, the bootstrap process may not need to be repeated during operation after running once to initialize the localization system. However, when the localization system's uncertainty about the vehicle's pose exceeds a threshold, the AV may alert the system to exit autonomous mode and return to manual driver operation because the system is no longer confident enough in its vehicle pose to navigate autonomously.

FIG. 9 illustrates an example computer system 900 in which various embodiments of the present disclosure can be implemented. Computer system 900 can be any computer capable of performing the functions and operations described herein. Computer system 900 can be implemented as, for example, vehicle on-board computing device 220 to execute one or more operations in method 600, for carrying out the ICP algorithm.

Computer system 900 can be any well-known computer capable of performing the functions described herein.

Computer system 900 includes one or more processors (also called central processing units, or CPUs), such as a processor 904. Processor 904 is connected to a communication infrastructure or bus 906.

One or more processors 904 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 also includes user input/output device(s) 903, such as monitors, keyboards, pointing devices, etc., that communicate with communication infrastructure 906 through user input/output interface(s) 902.

Computer system 900 also includes a main or primary memory 908, such as random access memory (RAM). Main memory 908 may include one or more levels of cache. Main memory 908 has stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 reads from and/or writes to removable storage unit 918 in a well-known manner.

According to an exemplary embodiment, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926.

The operations in the preceding embodiments can be implemented in a wide variety of configurations and architectures. Therefore, some or all of the operations in the preceding embodiments—e.g., method 700 of FIG. 7—can be performed in hardware, in software or both.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as controller 511), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method comprising:
generating, by one or more computing devices of an autonomous vehicle (AV), an initial pose estimate of the AV from Global Positioning System (GPS) data, the initial pose estimate including a reference map;
generating, by the one or more computing devices, an initial pose of the AV from the initial pose estimate, the generating comprising:
performing a Light Detection and Ranging (lidar) sweep to generate lidar data,
generating yaw angle candidates of the AV based on a correlation between the lidar data and the reference map,
generating position candidates of the AV based on the reference map,
combining the position candidates and the yaw candidates to generate a list of raw candidates, and
performing a search operation on the raw candidates to determine the initial pose of the AV; and
bootstrapping the AV by transitioning an operating mode of the AV from a running state to a localized state based on the initial pose when the AV is stationary.

2. The method of claim 1, further comprising transitioning an operating mode of the AV from a not-ready state indicative of AV motion to a running state when a linear speed of the AV is below a predetermined threshold.

3. The method of claim 1, further comprising:
issuing instructions to navigate the AV to a new location in response to a detected failure of the bootstrapping; and
in response to the AV being moved to a different location, transitioning an operating mode of the AV from a failed state to a running state.

4. The method of claim 1, wherein generating the yaw angle candidates further comprises aligning the reference map with the lidar data, using an iterative closest point (ICP) algorithm to improve accuracy of the map.

5. The method of claim 1, further comprising:
validating the initial pose of the AV, by a machine learning binary classifier operating on the one or more computing devices, the validating including:
determining a position and orientation of the AV; and
comparing the position and orientation to the initial pose determined from the lidar data.

6. The method of claim 5, wherein the validating further comprises using camera images from one or more ring cameras to visually validate the initial pose.

7. The method of claim 1, wherein generating the position candidates is based on a reference map derived from multiple GPS satellites, the reference map having a horizontal accuracy of at least ten meters.

8. A system comprising:
a Light Detection and Ranging (lidar) apparatus configured to perform a lidar sweep to generate lidar data; and
a computing device configured to:
generate an initial pose estimate of an autonomous vehicle (AV) from Global Positioning System (GPS) data, the initial pose estimate including a reference map;
generate an initial pose of the AV from the initial pose estimate;
generate yaw angle candidates of the AV based on a correlation between the lidar data and the reference map;
generate position candidates of the AV based on the reference map;
combine the position candidates and the yaw candidates to generate a list of raw candidates;
perform a search operation on the raw candidates to determine the initial pose of the AV; and
bootstrap the AV based on the determined initial pose when the AV is stationary.

9. The system of claim 8, wherein the computing device is further configured to transition operating mode of the AV from a not-ready state indicative of AV motion, to a running state when a linear speed of the AV is below a predetermined threshold.

10. The system of claim 8, wherein the computing device is further configured to:
issue instructions to navigate the AV to a new location in response to a detected bootstrap failure; and
in response to the AV being moved to a different location, transition an operating mode of the AV from a failed state to a running state.

11. The system of claim 8, wherein the computing device is further configured to align the reference map with the lidar data, using an iterative closest point (ICP) algorithm to improve accuracy of the map.

12. The system of claim 8, further comprising ring cameras configured to provide camera images to visually validate the initial pose during a visual validation procedure.

13. The system of claim 8, wherein the computing device is further configured to:
validate the initial pose of the AV, by a machine learning binary classifier operating on the one or more computing devices, the validating including:
determining a position and orientation of the AV; and
comparing the position and orientation to the initial pose determined from the lidar data.

14. The system of claim 8, wherein generating the position candidates is based on a reference map derived from multiple GPS satellites, the reference map having a horizontal accuracy of at least ten meters.

15. A non-transitory computer-readable medium having instructions stored thereon that, when executed by at least one computing device, cause the at least one computing device to perform operations comprising:
generating an initial pose estimate of an autonomous vehicle (AV) from Global Positioning System (GPS) data, the initial pose estimate including a reference map;
generating an initial pose of the AV from the initial pose estimate, the generating comprising:
performing a Light Detection and Ranging (lidar) sweep to generate lidar data,
generating yaw angle candidates of the AV based on a correlation between the lidar data and the reference map,
generating position candidates of the AV based on the reference map,
combining the position candidates and the yaw candidates to generate a list of raw candidates, and
performing a search operation on the raw candidates to determine the initial pose of the AV; and
bootstrapping the AV based on the determined initial pose, when the AV is stationary.

16. The non-transitory computer-readable medium of claim 15, wherein the operations further comprise:
transitioning an operating mode of the AV from a not-ready state indicative of AV motion to a running state when a linear speed of the AV is below a predetermined threshold.

17. The non-transitory computer-readable medium of claim 15, wherein the operations further comprise:
issuing instructions to navigate the AV to a new location in response to a detected failure of the bootstrapping; and
in response to the AV being moved to a different location, transitioning an operating mode of the AV from a failed state to a running state.

18. The non-transitory computer-readable medium of claim 15, wherein the instructions cause the at least one computing device to perform further operations comprising aligning the reference map with the lidar data using an iterative closest point (ICP) algorithm to improve accuracy of the map.

19. The non-transitory computer-readable medium of claim 15, wherein the instructions cause the at least one computing device to perform further operations comprising:
validating the initial pose of the AV, by a machine learning binary classifier operating on the one or more computing devices, the validating including:
determining a position and orientation of the AV; and
comparing the position and orientation to the initial pose determined from the lidar data.

20. The non-transitory computer-readable medium of claim 19, wherein validating comprises using camera images from one or more ring cameras to visually validate the initial pose.
